(19) United States
(12) Patent Application Publication
(10) Pub. No.: US 2006/0239143 A1
(43) Pub. Date: Oct. 26, 2006

(54) OPTICAL HEAD APPARATUS USING DOUBLE LAYER MEDIUM

(76) Inventors: Yuichiro YAMAMOTO, Tokyo (JP); Shinichi Tatsuta, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/277,080

(22) Filed: Mar. 21, 2006

(30) Foreign Application Priority Data
Apr. 21, 2005 (JP) 2005-123630

(51) Int. Cl. G11B 20/00; G11B 7/00

(52) U.S. Cl. 369/47.17; 369/53.33

(57) ABSTRACT

An optical head apparatus includes a focusing unit focusing the light beam on a selected one layer of a 0th and a first recording layers, a tracking unit tracking control to track the focused light beam on the selected layer, a first signal generator detecting reflected light from the optical disk and generate an output signal including information recorded on the selected layer and an undesired signal component due to other layer of the 0th and the first recording layer, a second signal generator generating a compensation signal equivalent to the signal component by using a relative eccentricity quantity between the 0th recording layer and the first recording layer and a position of the focused light beam on the optical disk with respect to a radial direction thereof, and a subtracter to subtract the compensation signal from the output signal to generate a reproduction signal.

### CROSS-REFERENCE TO RELATED APPLICATIONS

This application is based upon and claims the benefit of priority from prior Japanese Patent Application No. 2005-123630, filed Apr. 21, 2005, the entire contents of which are incorporated herein by reference.

### BACKGROUND OF THE INVENTION

1. Field of the Invention

The present invention relates to an optical head apparatus for recording and reproducing information using a light beam, particularly to an optical head apparatus, which reduces effects from leak lights reflected by the non-reproduction layer onto the reproduction signal upon reproduction of an optical disk comprising double recording layers.

2. Description of the Related Art

A double layer optical disk comprising two recording layers, which are united by an intermediate layer on one side of the substrate, is used on Digital Versatile Discs (DVD) for the purpose of increasing a recording information quantity. When an optical head apparatus reproduces the information written on the double layer optical disk, a light beam emitted from a light source is focused on one recording layer to be reproduced (hereinafter referred to as a reproduction layer) with an objective lens. The output signal from a light detector, which detects a reflected diffracted light beam from the reproduction layer, is subjected to a computation processing to generate a reproduction signal.

Meanwhile, as the other recording layer not to be reproduced, which is not the reproduction target (hereinafter referred to as the non-reproduction layer), is displaced from the focused position of the objective lens, the light beam irradiated on the non-reproduction layer is completely defocused, lacking sufficient resolution for reading the recorded information. However, the incident light beam on the non-reproduction layer undergoes reflection diffraction and enters the light detector as a so-called leak light. Such an undesirable leak light overlaps and interferes with the reflected light from the reproduction layer, resulting in deteriorating the quality of the reproduction signal. This problem is well known as the interlayer cross talk.

The characteristics of interlayer cross talk, which depend on the thickness of the intermediate layer (hereinafter referred to as interlayer thickness) of the double layer optical disk, are reduced to a certain extent by increasing the thickness of the interlayer thickness. However, since the objective lens is optimally designed for certain substrate thickness, if the interlayer thickness is increased, wavefront aberration may occur depending on the difference of substrate thickness. If the wavefront aberration is significant, the shape of the beam spot on the reproduction layer may deteriorate, thereby deteriorating the reproduction signal characteristic. Therefore, the interlayer thickness must be kept below the acceptable value of the wavefront aberration of the beam spot on the reproduction layer. In the case of, for example, an existent DVD, which uses a red light semiconductor laser with a wave length band of 650 nm and a 0.60 numerical aperture objective lens optimally designed for a protective layer of 0.6 mm in thickness, its interlayer thickness is set at 55±15 μm. When the interlayer thickness is 55 μm, the root mean square of wave front error (rms) value of the wavefront aberration on the reproduction layer is inasmuch as 27 mλ (λ is the laser wave length) at calculated value for both two layers. As a result of these measures, interlayer cross talks on DVDs are reduced down to practical levels.

Meanwhile, a high density next-generation optical disk having a memory size three to four times of the existent DVDs, has been developed. According to an example of the next-generation optical disk, a blue-violet light semiconductor laser having a 400 nm band in wave length and a 0.65 numerical aperture objective lens optimally designed for a protective layer thickness of 0.6 mm are used in the light of, for example, compatibility between DVDs and CDs, easy production of thin drives for notebook computers, and low disk production costs. In these next-generation optical disk systems, likewise DVDs, a double layer optical disk has been developed for the purpose of increasing memory size.

An interlayer thickness of a next generation double layer optical disk is extremely as thin as 23 μm when provided on the standard basis of a double layer DVD, which has a wavefront aberration of 27 mλ for an interlayer thickness of 55 μm. The reason for reducing the interlayer thickness is because the spherical aberration generated in response to the substrate thickness difference is just about proportional to the fourth power of the numerical aperture of the objective lens and inversely proportional to the laser wavelength. As the interlayer thickness for the next generation double layer optical disk is narrow in such way, the influence from an interlayer cross talk is significant when compared to DVDs. Therefore, in the case of a next-generation double layer optical disk, it is difficult to reduce the interlayer cross talk to practical levels in the manners carried out for DVDs. Accordingly, in the development of the next-generation double layer optical disk, it is necessary to design an optical head apparatus which incorporates measures against the interlayer cross talk.

Patent application publication 2002-319177 discloses a measure for reducing interlayer cross talk. In the disclosed measure, a first light detection region, which detects undesired leak light (interlayer cross talk) from the non-reproduction layer, is arranged in the vicinity of a second light detector region, which detects reproduction signals. The interlayer cross talk is canceled by subtracting the signal detected at the first light detection region from the signal detected at the second light detection region.

The influence of interlayer cross talk on the reproduction signal can be divided roughly into the level fluctuation and the low-frequency fluctuation of the reproduction signal. The former effect regarding the level fluctuation of the reproduction signal is caused by the reflectivity difference in the recorded region and the unrecorded region of the non-reproduction layer. The latter is a result of alterations in the state of interference between the signal light from the reproduction layer and the undesired leak light from the non-reproduction layer detected by the light detector. Although the measure for reducing interlayer cross talk specified on patent application publication 2002-319177 is effective for the former level fluctuation, it is not effective for the low-frequency fluctuation of the reproduction signal. Owing to the fact that low-frequency fluctuation of the reproduction signal caused by the interlayer cross talk had not been as obvious enough to occur as a problem relating to conventional DVDs and that the cause of low-frequency fluctuation of the reproduction signal does not attribute to the cause of the level fluctuation, effective measures to reduce low-frequency fluctuation of reproduction signals have not yet been discovered at this point.

### BRIEF SUMMARY OF THE INVENTION

It is an object of the present invention to provide an optical head apparatus comprising: a light source to generate a light beam, a focusing unit configured to focus the light beam on a selected one layer of a 0th recording layer and a first recording layer of an optical disk; a tracking unit configured to perform tracking control to track the focused light beam on the selected layer; a first signal generator including a light detector to detect reflected light from the optical disk and generate an output signal including information recorded on the selected layer and an undesired signal component due to other layer of the 0th recording layer and the first recording layer; a second signal generator to generate a compensation signal equivalent to the signal component by using a relative eccentricity quantity between the 0th recording layer and the first recording layer and a position of the focused light beam on the optical disk with respect to a radial direction thereof; and a subtracter to subtract the compensation signal from the output signal to generate a reproduction signal.

### BRIEF DESCRIPTION OF THE SEVERAL VIEWS OF THE DRAWING

FIG. 1 is a schematic view that shows an optical head apparatus in accordance with an embodiment of the present invention;

FIG. 2 is a diagram showing an example of a compensation signal generator shown in FIG. 1;

FIG. 3 illustrates a recorded or unrecorded state of a reproduction layer and non-reproduction layer;

FIG. 4 illustrates a reproduction signal when a light beam passes through a region of a non-reproduction layer, in which data is written intensively;

FIG. 5 illustrates an example of a reproduction signal of a rewritable single layer optical disk;

FIG. 6 illustrates an example of a reproduction signal of a rewritable double layer optical disk showing low-frequency fluctuation;

FIG. 7 illustrates an example of the electric field distribution of the signal light and leak light on a light detector;

FIGS. 8A and 8B illustrate a lateral view and plain view explaining the relative eccentricity, which occurs between the two recording layers upon the production process of the double layer optical disk;

FIG. 9 illustrates an example of beam trajectories on the reproduction layer and non-reproduction layer when a relative eccentricity exists between the two recording layers;

FIG. 10 illustrates the positional relations of the light beam and the track of the non-recording layer;

FIG. 11 illustrates an example of the output signal generated by the reproduction detecting unit;

FIG. 12 illustrates an example of a measuring unit for measuring the relative eccentricity quantity of the two recording layers;

FIGS. 13A and 13B illustrate an example of a tracking error signal of the 0th recording layer and the first recording layer;

FIG. 14 illustrates an example of a tracking drive signal of the 0th recording layer and the first recording layer; and

FIG. 15 illustrates an example of the relationship between the absolute eccentricity of the 0th recording layer and the first recording layer and the phase difference of the tracking drive signal.

### DETAILED DESCRIPTION OF THE INVENTION

Hereinafter, embodiments of the present invention will be described in detail with reference to the accompanying drawings. According to the present embodiment, a rewritable type double layer optical disk, whereby the reproduction signal is rather severely affected by an interlayer cross talk than in the case of a reproduction only type, is adopted. Further, a land/groove structure, which is the most common structure used for a rewritable type optical disk, is presumed for the optical disk structure of the present invention.

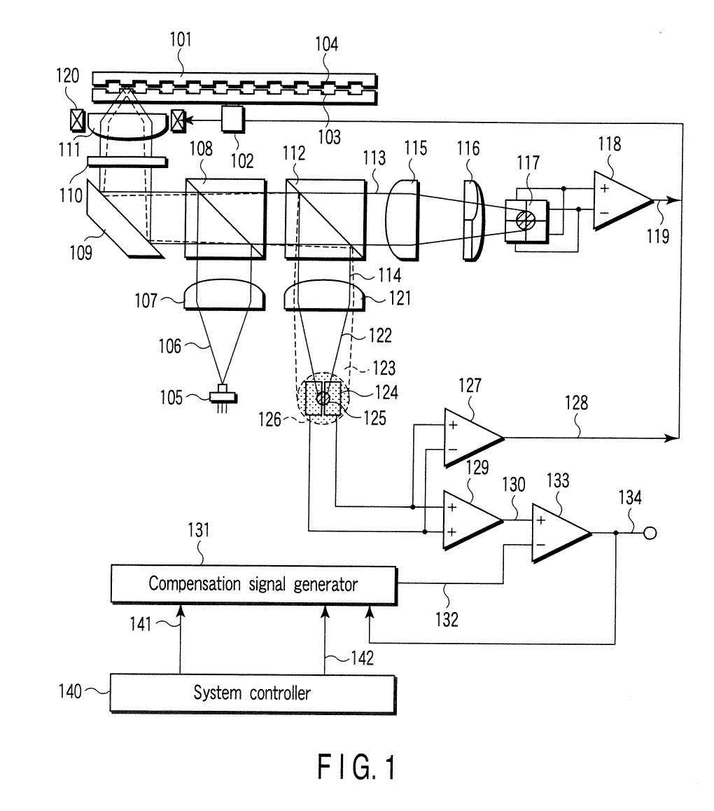

FIG. 1 shows an optical head apparatus concerning one of the embodiments in the present invention. An optical disk 101 is a double layer optical disk comprising two recording layers 103 and 104, which respectively have a spiral groove region and a land region. In a land/groove structured rewritable type optical disk, both the groove region and the land region are recordable. A recording layer 103, which is close to the incident side of the light beam, is called the 0th recording layer, and a recording layer 104, which is distant from the incident side of the light beam, is called the first recording layer. That is, generally in the field of the optical disc, the 0th recording layer is written as L0 layer, and the 1st recording layer is written as L1 layer. The optical disk 101 is rotated by a spindle motor 102 upon recording or reproduction.

When recording information on the 0th recording layer 103 or the first recording layer 104 or reproducing information from the 0th recording layer 103 or the first recording layer 104, a light beam is focused on the recording layer to be recorded or the recording layer to be reproduced (reproduction layer) by a light emitter comprising a laser source 105, collimator lens 107, polarizing beam splitter 108, uprise mirror 109, quarter wavelength plate 110 and objective lens 111.

In explanation of the reproduction mechanism, a linear polarized light beam 106, which is emitted from the laser source 105, is converted from a divergent light beam to a parallel light beam through the collimator lens 107, is sequentially reflected by the polarizing beam splitter 108 and the uprise mirror 109, and enters the quarter wavelength plate 110. The incident parallel light beam on the quarter wavelength plate 110 is converted into a circularly polarized light and is focused on the reproduction layer of the double layer optical disk 101 by the objective lens 111.

The light reflected by the reproduction layer passes through the objective lens 111 and quarter wavelength plate 110 from the direction opposite the incident light and is converted into a linear polarized light beam by the quarter wavelength plate 110. The linear polarized light beam is reflected by the uprise mirror 109 and is transmitted through the polarizing beam splitter 108. The light beam transmitted through the polarized light beam splitter 108 is split up into a focusing control light beam 113 and a tracking control/reproduction light beam 114 by a beam splitter 112.

The focusing control light beam 113 transmitted through the beam splitter 112 is focused on the first light detector 117 by a condenser lens 115 and cylindrical lens 116. The first light detector 117, which is a four-divided photodetector (a quadrant photodetector), generates an output signal in accordance with each amount of incident light received on each acceptance surface of the quadrant photodetector. The output signal corresponding to each acceptance surface of the light detector 117 is input to a focal point error computing unit 118, where a focal point error signal 119 is generated by computing on the basis of the heretofore known computing equation of the astigmatism method.

The objective lens 111 is activated in a vertical direction against the surface of the recording layers 103 and 104 by the lens actuator 120 based on the focal point error detector signal 119. Herewith, the light beam is focused on the reproduction layer. In the present embodiment a representative astigmatism method has been introduced as a focal point error detecting method. However, other methods, such as the Knife edge method or the beam size detection method, is used.

The tracking control/reproduction light beam 114 reflected by the beam splitter 112 is condensed by a condenser lens 121 onto the second light detector 124. The second light detector 124 is a divided photodetector comprising at least two divided acceptance surfaces which generate output signals in accordance with the amount of each incident light received on each acceptance surface. The relevant output signals of the acceptance surfaces of the second light detector 124 are input to the tracking error computing unit 127 and subjected to a computing process based on a known computing equation to generate a tracking error signal 128.

In the case where the second light detector 124 is a two-divided photodetector, the tracking error computing unit 127 is a subtracter (or a differential amplifier). A tracking error signal 128 generated by the subtracter is called a push-pull signal. The objective lens 111 is activated towards the inner surface of the recording layers 103 and 104 in accordance with the tracking drive signal generated based on the tracking error signal 128 by the lens actuator and positions the light beam on the target track of the reproduction layer.

The output signals corresponding to the acceptance surfaces of the second light detector 124 also are input to a reproduction computing unit 129. In the case where the second light detector 124 is a divided photodetector, the reproduction computing unit 129 is an adder (or an adding amplifier) which, by adding the output signals corresponding to the acceptance surfaces of the second light detector 124, generates an output signal 130 corresponding to the information recorded on the reproduction layer of the optical disk 101.

The light beam 122 of the incident light beam entering the second light detector 124, which is indicated by a solid line is a light beam (signal beam) reflected by the reproduction layer (the first recording layer 104 in FIG. 1) of the double layer optical disk 101. The light beam 123 indicated by a dotted line shows the light beam reflected by the non-reproduction layer (the 0th recording layer 103 in FIG. 1) of the double layer optical disk 101. The light beams 122 and 123 correspond respectively to beam spots 125 and 126 in the second light detector 124.

The second light detector 124 receives the undesired leak light beam 123 as well as the reproduction layer light beam 122, whereby the leak light beam 123 overlaps with the light beam 122 and interferes therewith. As a result of transition in the state of interference between the signal light beam 122 and the leak light beam 123, low-frequency fluctuation occurs on the output signal 130 generated by the reproduction computing unit 129. A compensation signal 132, which compensates the low-frequency fluctuation of the output signal 130, is generated by the compensation signal generator 131. The subtracter (or the differential amplifier) 133 subtracts the compensation signal 132 from the output signal 130 of the reproduction computing unit 129 to output a reproduction signal 134 compensated for a low-frequency fluctuation.

The compensation signal generator 131 generates the compensation signal 132 by receiving, from the system controller 140, relative eccentricity quantity information 141, which indicates the relative eccentricity quantity between the 0th recording layer 103 and the first recording layer 104 (center declination of the land/groove structure between the 0th recording layer 103 and the first recording layer 104), and beam position information 142, which indicates the position of the light beam irradiated on the optical disk 101 with respect to the radial direction of the optical disk (hereinafter simply referred to as a disk radial position of a light beam). The compensation signal 132 is a signal (also called as a track crossing false signal) equivalent to a signal generated by the reproduction computing unit 129 when the light beam crosses the track in a state where the light beam irradiated on the optical disk 101 converges on the non-reproduction layer and the tracking control for the reproduction layer track is shut down (i.e., a signal generated by the reproduction computing unit 129 due to the light reflected by the non-reproduction layer upon light beam irradiation on the reproduction layer). Further in detail, the compensation signal 132 has a waveform of a frequency response, which is determined by the relative eccentricity quantity between the 0th recording layer 103 and the first recording layer 104 and the disk radial position of the light beam irradiated on the optical disk 101.

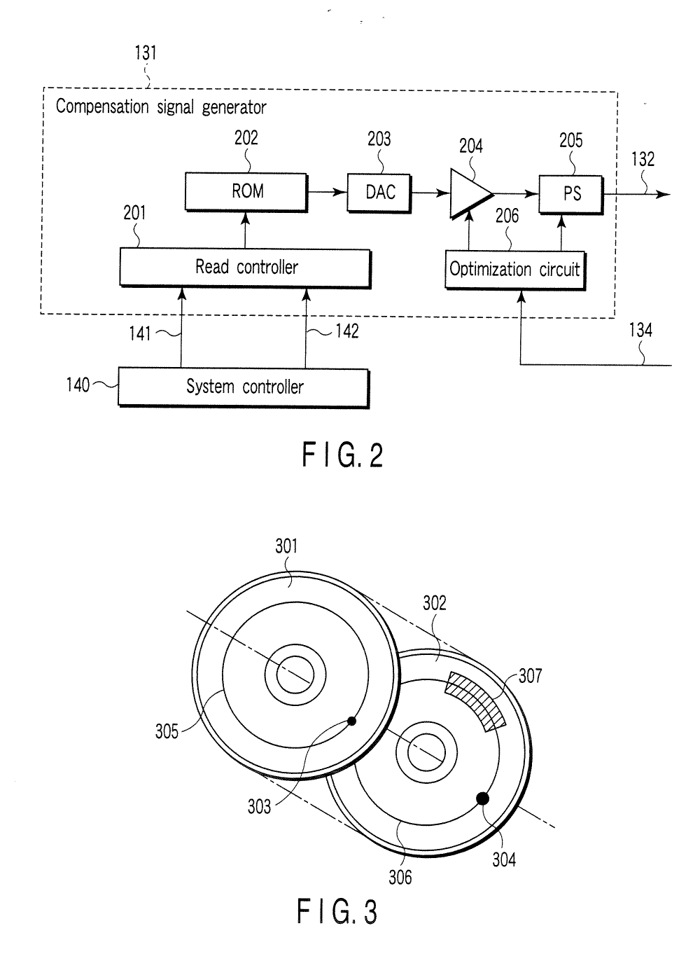

FIG. 2 shows an example of an embodiment of the compensation signal generator 131. In FIG. 2, the relative eccentricity quantity information 141 and the beam position information 142 are provided to the read controller 201 from the system controller 140. Each optical disk has its own value of relative eccentricity quantity. For example, specific information on each optical disk including the relative eccentricity quantity is written into the read-in region of the innermost circumference of the optical disk 101. In such case, the system controller 140 generates the relative eccentricity quantity information 141 by reading the information written in the read-in region upon initiating reproduction and supplies it to the read controller 201. Meanwhile, as the position on which the light beam is to be irradiated on the optical disk 101 upon reproduction is given, the beam position information 142 is easily generated by the system controller 140.

Waveforms of reproduced signals previously obtained from various optical disks, and each corresponding to a circuit of the disk or half circuit thereof, are stored in a read only memory (ROM) 202 in digital value sequence as the source of the compensation signal 132. A read controller 201 generates readout addresses based on the relative eccentricity information 141 and the beam position information 142, and readout clocks. The digital value sequence is read out from ROM 202 according to these read addresses and read clocks. The digital value sequence read out from ROM 202 is converted into an analog signal by the digital-to-analog converter (DAC) 203. The signal amplitude and phase of the output signal from DAC 203 are properly adjusted by a variable gain amplifier 204 and a variable phase shifter 205 upon necessity in order to generate a compensation signal 132. The gain of the variable gain amplifier 204 and the phase shift quantity of the phase shifter 205 are controlled by the optimization circuit 206 to optimize the reproduction signal 134.

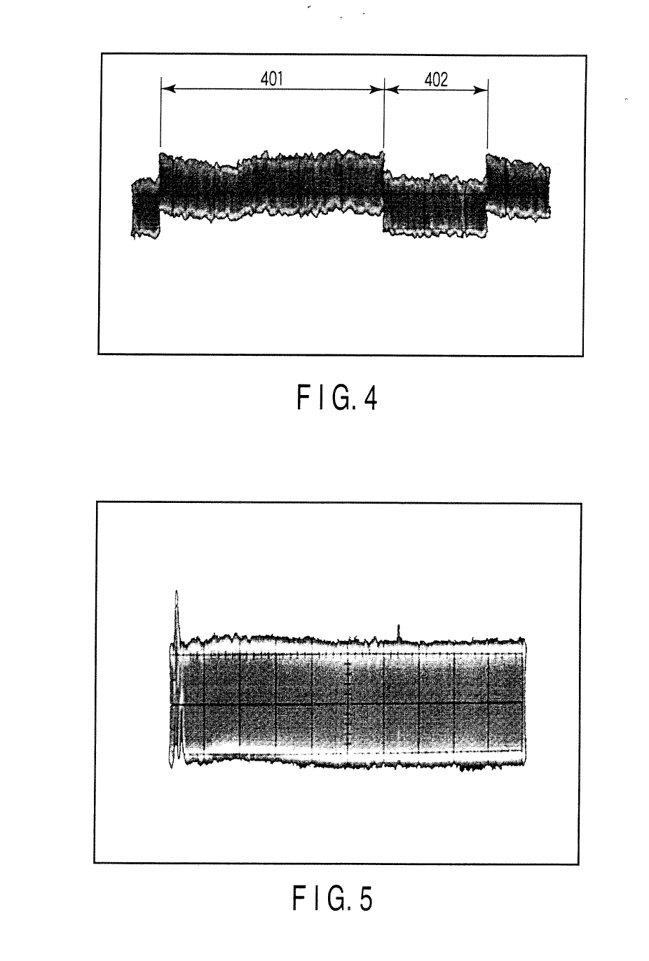

As mentioned earlier, the influence of an interlayer cross talk of a double-layer optical disk on a reproduction signal is generally classified into a level fluctuation of the reproduction signal and a low-frequency fluctuation. In the former phenomenon, the reproduction signal level fluctuates due to the reflectivity difference between the recorded region and the unrecorded region of the non-reproduction layer. For example, the level fluctuation of the reproduction signal occurs when the beam passes though an area of a non-reproduction layer in which data is intensively written. In reference to FIGS. 3 and 4, FIG. 3 shows a rewritable type double layer optical disk indicating a light beam 303 and beam trace 305 on the reproduction layer 301 and a light beam 304 and beam trace 306 on the non-reproduction layer 302. Reflectivity of the non-reproduction layer 302 varies significantly in the vicinity of the region 307 in FIG. 3 in which data is intensively written. Therefore, as indicated in FIG. 4, the reproduction signal level differs significantly between a zone 401 indicating a region other than the region 307, and a zone 402 indicating the region 307. Such level fluctuation of the reproduction signal may occur not only when the light beam passes through the region 307 in which data is intensively written but also when the beam passes through the address pit region of the non-reproduction layer due to significant reflectivity difference between the land/groove region and pit region of the disk. Such level fluctuation in the reproduction signal is compensated by the skill of public knowledge, for example, as specified in the patent publication 2002-319177.

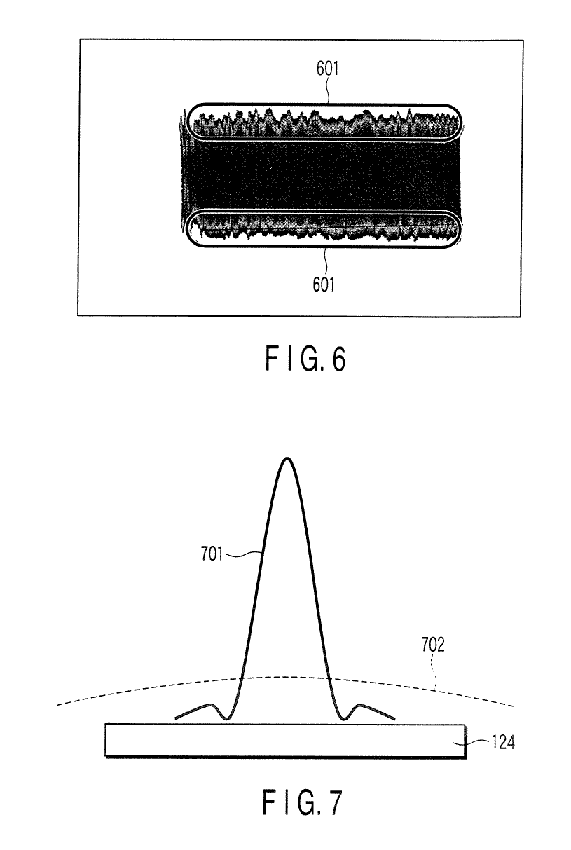

On the other hand, the latter low-frequency fluctuation of the reproduction signal is caused by the variance in the state of interference between the signal light from the reproduction layer and the leak light from the non-reproduction layer detected on the light detector. In reference to FIGS. 5 and 6, FIG. 5 indicates a reproduction signal using a rewritable type single layer optical disk for comparison, and FIG. 6 indicates an example of a reproduction signal using a rewritable type double layer optical disk as presented in the present embodiment. In reference to the rewritable type double layer optical disk, low-frequency fluctuation is observed on the reproduction signal envelope 601 as indicated in FIG. 6. This phenomenon may not be observed on a single layer disk, therefore, is a unique phenomenon of a double layer optical disk, which may deteriorate the characteristics of the reproduction signal. The present embodiment will compensate such low-frequency fluctuation of the reproduction signal.

Here, the cause of low-frequency fluctuation of the reproduction signal will be explained further in detail. FIG. 7 is a typical diagram of a signal light distribution 701 from the reproduction layer and a leak light distribution 702 from the non-reproduction layer, which are observed on the second light detector 124. The leak light from the non-reproduction layer overlaps the signal light on the second light detector 124 and interferes therewith, whereby the output signal of the second light detector 124 is affected.

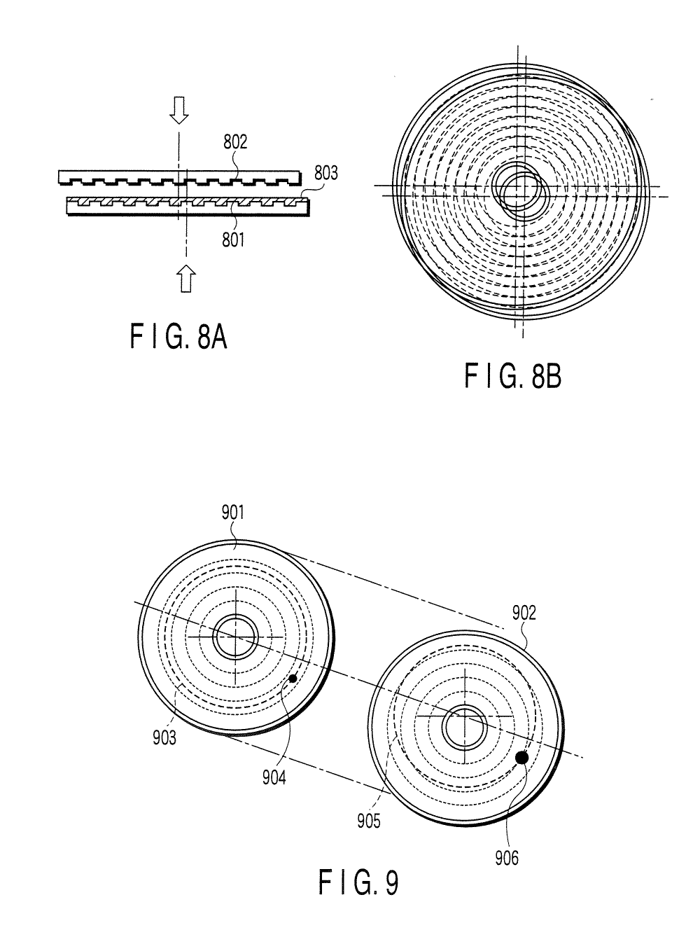

In the manufacturing process of the double layer optical disk, the 0th recording layer 801 and the first recording layer 802 are bonded together by the intermediate layer (adhesive layer) 803 sandwiched between the recording layers 801 and 802, as shown in FIGS. 8A and 8B. As a result of such manufacturing process, relative eccentricity occurs inevitably between the recording layers 801 and 802 as indicated in FIGS. 8A and 8B. In consideration of the mechanical error to occur upon adhesion of the recording layers 801 and 802, as well as the displacement due to drying the adhesion, it is extremely difficult to mass-produce an optical disk by avoiding relative eccentricity on the recording layers 801 and 802 upon adhesion.

As a result of the above eccentricity, when focusing control and tracking control are carried out on the reproduction layer upon reproduction, in contrast to the trace 903 of a light beam 904, which follows the track on a reproduction layer 901, the trace 905 of a light beam 906 travels across a track on a non-reproduction layer 902 as shown in FIG. 9.

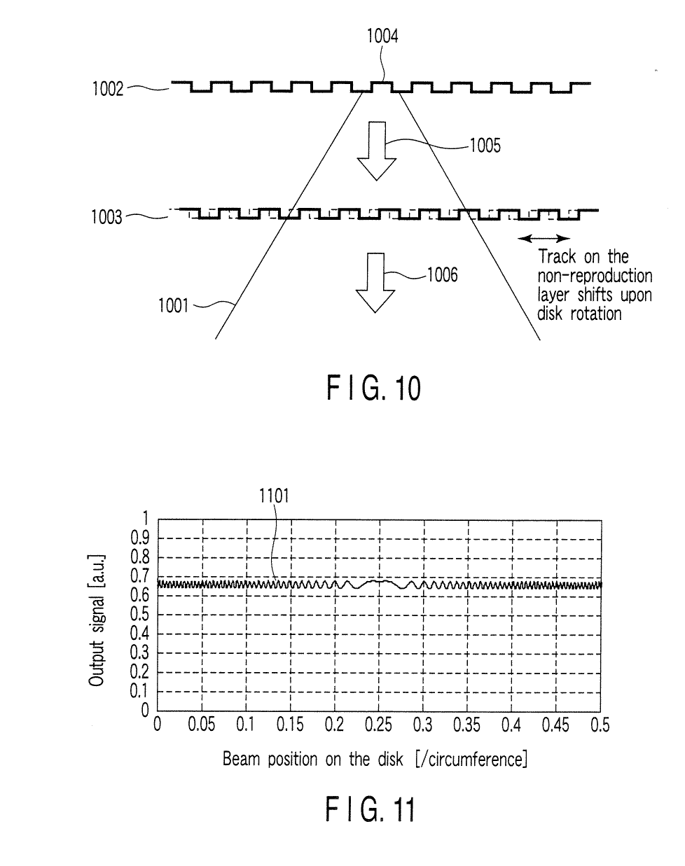

FIG. 10 illustrates a positional relation between a light beam and a non-reproduction layer track upon disk rotation. A focused light 1001 emitted through an objective lens 111 follows a reproduction track 1004 on a reproduction layer 1002 so as to carry out tracking control. When there is relative eccentricity between the reproduction layer 1002 and a non-reproduction layer 1003, a positional relation between the light beam and the track on the non-reproduction layer 1003 changes upon disk rotation. The distribution of light diffracted by the land/groove structure of the non-reproduction layer 1003, reflects the structure of the track on the non-reproduction layer 1003. Therefore, the distribution of leak light from the non-reproduction layer 1003, which is received on the second detector 124, varies with the disk rotation. Accordingly, the state of interference between the signal light from the reproduction layer 1002 and the leak light from the non-reproduction layer 1003, which are received on the second light detector 124, varies with the disk rotation, which results in the fluctuation of output signal generated from the second light detector 124. This is the low-frequency fluctuation of the reproduction signal.

The following explains the reason for subtracting from the output signal 130 of the reproduction operational unit the compensation signal with a waveform having a frequency response determined by the relative eccentricity quantity between the 0th recording layer and the first recording layer and the disk radial position of the light beam irradiated on the optical disk 101.

The number of tracks of the non-reproduction layer the light beam tracking the track of the reproduction layer crosses while the optical disk rotates one revolution depends on the relative eccentricity quantity of the double layer. Meanwhile, the number of tracks of the non-reproduction layer the light beam crosses on the inner and outer circumferences of the disk while the optical disk rotates one revolution is much the same between the inner and outer circumferences of the disk. Accordingly, in the Zoned Constant Linear Velocity (ZCLV) rotary system adopted for DVDs, the number of tracks crossed within a unit time depends on the disk radial position.

FIG. 11 shows a result of analyzing the output signal 130 generated by the reproduction computing unit 129 when the relative eccentricity quantity between the 0th recording layer and the first recording layer is 30 μm and the reproduction layer and non-reproduction layer both remain unrecorded. A waveform 1101 presented in FIG. 11 indicates the variation in the output signal 130 with respect to variation of the relative position between the light beam irradiated on the optical disk 101 and the optical disk 101 in the rotation direction of the optical disk. The cited waveform corresponds to half the circumference of the optical disk 101. As shown in FIG. 11, the waveform of the output signal 130 fluctuates in low frequency, which possesses a similar frequency response to the output signal 130 obtained when the light beam crosses the tracks of the non-reproduction layer.

In the compensation signal generator 131 illustrated in FIG. 2, the information of waveform 1101 shown in FIG. 11, for example, is written in the ROM 202 in advance as a digital value sequence forming a basis of the compensation signal 132. The waveform 1101 indicates a low-frequency oscillation of the output signal 130 with respect to a certain disk radial position (referred to as a reference disk radial position). The low-frequency oscillation waveform of the output signal 130 corresponding to another disk radial position resembles the waveform 1101, and the oscillation frequency, i.e., the time axial length of the low-frequency oscillation waveform, differs from the certain disk radial position.

In the ZCLV rotary system, the frequency of the low-frequency oscillation increases as the rotation frequency increases towards the inner circumference. Accordingly, a low-frequency oscillation waveform of a radial position other than that of a reference disk radial position is obtained by changing the time axis of the low-frequency oscillation waveform 1101 of the reference disk radial position in accordance with the radial distance from the reference disk radial position. For example, if the reference disk radial position is somewhere in mid-course of the radial direction, the time axis of the waveform 1101 should be compressed at the inner circumference of the reference disk radial position whereas the time axis of the waveform 1101 should be elongated at the outer circumference of the reference disk radial position. The compression and elongation of the time axial are carried out by changing the frequency (cycle) of the readout clock supplied to the ROM 202 from the read controller 201, according to the disk radial position. If the read clock frequency is increased in comparison with the case of the reference disk radial position, the time axial is compressed, whereas, if the read clock frequency is reduced, the time axial is elongated. The readout clock frequency at the reference disk radial position is determined in accordance with the disk radial distance from the reference disk radial position.

By controlling the read clock frequency in the above manner, a low-frequency oscillation waveform having a frequency response corresponding to the disk radial position is read out in digital value sequence from ROM 202. The readout digital value sequence is converted into an analog signal by DAC 203. By further adjusting the amplitude and phase of the analog signal by the variable gain amplifier 204 and the variable phase shifter 205 upon necessity, the compensation signal 132 having a frequency response corresponding to the disk radial position is generated.

Although the output signal received from DAC 203 includes necessary waveform information as a compensation signal, it may not necessarily mean that the amplitude and phase are pertinent to the output signal from the reproduction computing unit 129. Consequently, in order to minimize the jitter or error of the reproduction signal 134 generated by the subtracter 133, at least one of the gain of the variable gain amplifier 204 and the phase shift quantity of the variable phase shifter 205 is adaptively changed to change at least one of the amplitude and phase of the compensation signal 132. In this manner, a reproduction signal 134 having an effectively suppressed low-frequency oscillation can be obtained.

As explained above, according to the present embodiment, it is possible to provide a reproduction signal 132 wherein low-frequency fluctuation is reduced, by subtracting from the output signal 130 of the reproduction computing unit 129 the compensation signal 132 generated by the compensation signal generator 131 and determined by the relative eccentricity quantity between the 0th recording layer 103 and the first recording layer 104 and the disk radial position of the light beam on the optical disk 101.

In the foregoing explanation, the relative eccentricity quantity between the 0th recording layer and the first recording layer of the optical disk is explained as a known value. Alternatively, the relative eccentricity quantity may be used by being measured in an optical head device each time an optical disk is loaded in a reproduction appliance including the optical head apparatus.

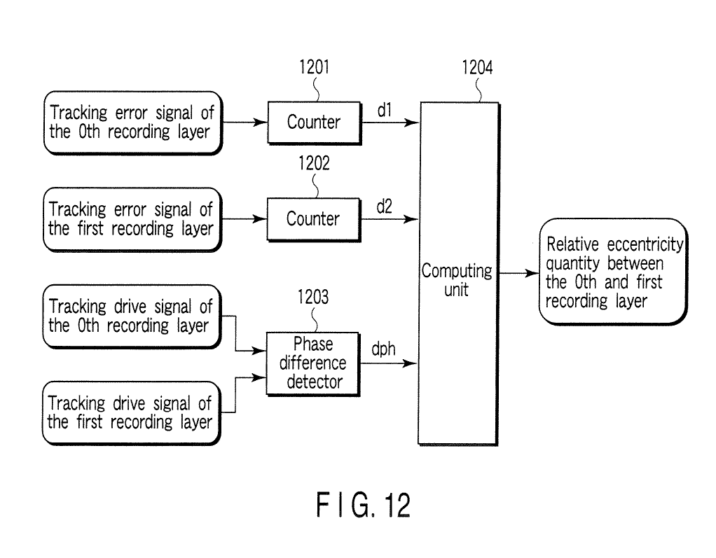

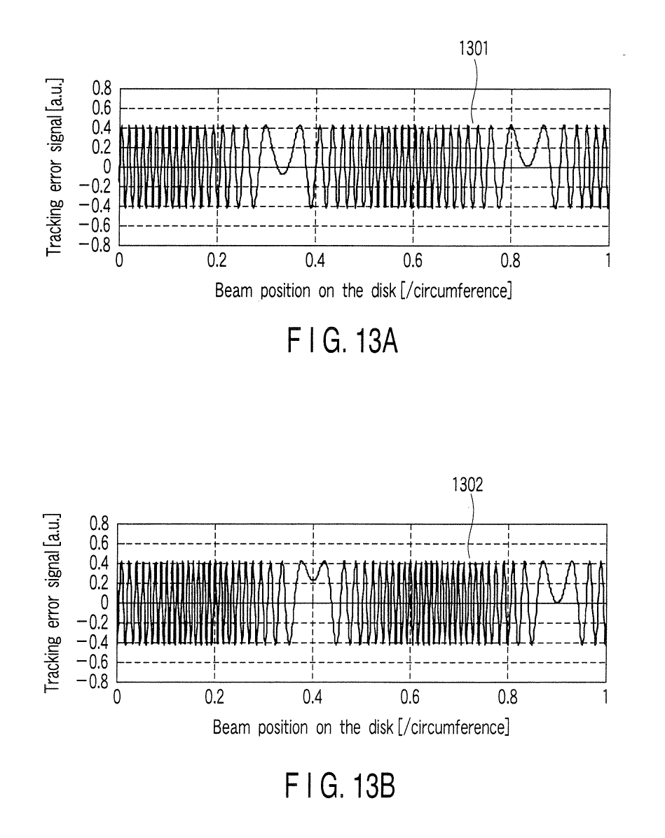

FIG. 12 is an example of a relative eccentricity quantity measurement unit, which, for example, is built into the system controller 140 or connected to the system controller 140. At first, focusing control is carried out respectively on the 0th recording layer and the first recording layer in order to retrieve tracking error signals corresponding to the 0th recording layer and the first recording layer, as shown in FIGS. 13A and 13B, as the output signal 130 of the reproduction computing unit 129 of FIG. 1.

Counters 1201 and 1202 count waves of the two tracking error signals with respect to a track circuit to obtain the numbers k1 and k2 of waves. The eccentricity quantities (absolute eccentricity quantities) d1 and d2 of the 0th recording layer and the first recording layer are calculated by the following equations (1) and (2).

$$\begin{matrix}d 1 = \frac{k 1}{4 Gp} & ( 1 ) \\ d 2 = \frac{k 2}{4 Gp} & ( 2 )\end{matrix}$$

Here, Gp represents the groove pitch of the optical disk.

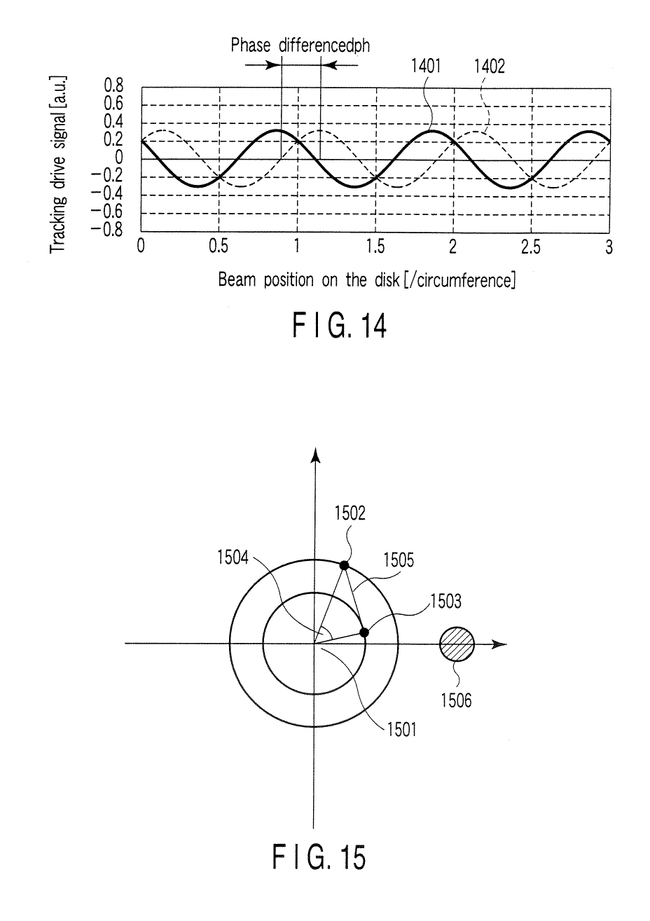

Meanwhile, by carrying out focusing control and tracking control respectively on the 0th recording layer and the first recording layer, a tracking drive signal, which determines the targeted track position for the objective lens, is obtained as shown in FIG. 14. In FIG. 14, the solid line represents the tracking drive signal of the 0th recording layer, whereas the dotted line represents the tracking drive signal of the first recording layer. The phase difference dph between the two tracking drive signals is detected by a phase difference detector 1203.

FIG. 15 illustrates the correlation of the absolute eccentricity quantity of each of the 0th recording layer and the first recording layer and the phase difference dph between the tracking drive signals as obtained above. In FIG. 15, trajectories with respect to the centers of the 0th recording layer and the first recording layer are illustrated on a coordination system fixed to a space with its origin point at the center of the spindle (rotation center of the disk). The distance from the spindle center 1501 to the center of the 0th recording layer 1502 and the distance from the spindle center 1501 to the center of the first recording layer 1503 correspond to the eccentricity quantities d1 and d2, and the phase difference 1504 between both centers 1501 and 1502 corresponds to the phase difference dph.

Accordingly, as it is obvious from the geometric correlations shown in FIG. 15, the relative eccentricity quantity 1505 of the 0th recording layer and the first recording layer is calculated by d1, d2 and dph in the following equation (3).
dr=\sqrt{d1²+d2²−2d1·d2·sin dpn} (3)

As mentioned above, according to the embodiments of the present invention, an optical head apparatus having favorable reproduction signal characteristics with high reliability is provided. The optical head apparatus minimizes the low-frequency fluctuation of the reproduction signal, which is caused by undesirable light reflection from the non-reproduction layer due to interlayer cross talk when reproducing information of the double layer optical disk.

According to the above embodiment, a waveform corresponding to a disk radial position of a single optical disk is stored in ROM 202 as a source of the compensation signal 132. However, a plurality of waveforms corresponding to various disk radial positions of plural optical disks may be stored in ROM. In this case, a waveform corresponding to a disk radial position in reproduction is generated by interpolation calculation of the waveforms whereby a compensation signal 132 is generated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical head apparatus for reproducing information from an optical disk having a 0th recording layer and a first recording layer, comprising:
a light source to generate a light beam,
a focusing unit configured to focus the light beam on a selected one layer of a 0th recording layer and a first recording layer of an optical disk;
a tracking unit configured to perform tracking control to track the focused light beam on the selected layer;
a first signal generator including a light detector to detect reflected light from the optical disk and generate an output signal including information recorded on the selected layer and an undesired signal component due to other layer of the 0th recording layer and the first recording layer;
a second signal generator to generate a compensation signal equivalent to the signal component by using a relative eccentricity quantity between the 0th recording layer and the first recording layer and a position of the focused light beam on the optical disk with respect to a radial direction thereof; and
a subtracter to subtract the compensation signal from the output signal to generate a reproduction signal.

2. An optical head apparatus according to claim 1, wherein the second signal generator is configured to derive the relative eccentricity quantity from relative eccentricity quantity information recorded on the optical disk.

3. An optical head apparatus according to claim 1, further comprising: a first detector to derive an eccentricity quantity of the 0th recording layer from a first tracking error signal obtained when the light beam is focused on the 0th recording layer by the focusing unit;
a second detector to derive an eccentricity quantity of the first recording layer from a second tracking error signal obtained when the light beam is focused on the first recording layer by the focusing unit;
a third detector to detect a phase difference between a first tracking drive signal and a second tracking drive signal, the first tracking drive signal being obtained when the light beam is focused on the 0th recording layer by the focusing unit and the tracking control is performed for the 0th recording layer, and the second tracking drive signal being obtained when the light beam is focused on the first recording layer by the focusing unit and the tracking control is performed for the first recording layer by the tracking unit; and
a relative eccentricity quantity computing unit configured to compute the relative eccentricity quantity from the eccentricity quantity of the 0th recording layer, the eccentricity quantity of the first recording layer and the phase difference.

4. An optical head apparatus according to claim 3, wherein the relative eccentricity quantity computing unit is configured to compute the relative eccentricity quantity in a following equation:
dr=\sqrt{d1²+d2²−2d1·d2·sin dpn}
where, dr represents the relative eccentricity quantity; d1 represents the eccentricity quantity of the 0th recording layer; d2 represents the eccentricity quantity of the first recording layer; and dpn represents the phase difference.

5. An optical head apparatus, according to claim 1, wherein the second signal generator comprises:
a memory to store a plurality of waveform information corresponding to a plurality of compensation signals in digital value sequence;
a read controller to read out one of the waveform information from the memory in accordance with information indicating the relative eccentricity quantity; and
a digital-to-analog converter to convert the waveform information read out from the memory to an analog signal to generate the compensation signal.

6. An optical head apparatus, according to claim 5, wherein the read controller is configured to read out waveform information selected according to the information indicating the relative eccentricity quantity by subjecting it to time axis conversion in accordance with the information indicating the position of the focused light beam.

7. An optical head apparatus, according to claim 5, wherein the read controller is configured to read out the selected waveform information by carrying out time axis conversion to increase the frequency as the light beam position nears the inner circumference of the optical disk in accordance with information indicating the position of the focused light beam.

8. An optical head apparatus according to claim 1, wherein the second signal generator comprises a variable gain amplifier to adjust optimally an amplitude of the compensation signal to minimize one of a jitter and error rate of the reproduction signal.

9. An optical head apparatus according to claim 1, wherein the second signal generator comprises a variable phase shifter to adjust optimally the phase of the compensation signal to minimize one of a jitter and error rate of the reproduction signal.

10. An optical head apparatus for reproducing information from an optical disk having a 0th recording layer and a first recording layer, comprising:
a light source to generate a light beam,
a focusing unit configured to focus the light beam on a selected one layer of a 0th recording layer and a first recording layer of an optical disk;
a tracking unit configured to perform tracking control to track the focused light beam on the selected layer;
a first signal generator including a light detector to detect reflected light from the optical disk and generate an output signal including information recorded on the selected layer;
a second signal generator to generate a compensation signal based on a relative eccentricity quantity between the 0th recording layer and the first recording layer and a position of the focused light beam on the optical disk with respect to a radial direction thereof, the compensation signal being equivalent to the output signal of the first signal generator when the light beam is focused on other layer of the 0th recording layer and the first recording layer by the focusing unit and the tracking control of the tracking unit is turned off; and
a subtracter to subtract the compensation signal from the output signal to generate a reproduction signal.

11. An optical head apparatus according to claim 10, wherein the second signal generator is configured to derive the relative eccentricity quantity from relative eccentricity quantity information recorded on the optical disk.

12. An optical head apparatus according to claim 10, further comprising: a first detector to derive an eccentricity quantity of the 0th recording layer from a first tracking error signal obtained when the light beam is focused on the 0th recording layer by the focusing unit;
a second detector to derive an eccentricity quantity of the first recording layer from a second tracking error signal obtained when the light beam is focused on the first recording layer by the focusing unit;
a third detector to detect a phase difference between a first tracking drive signal and a second tracking drive signal, the first tracking drive signal being obtained when the light beam is focused on the 0th recording layer by the focusing unit and the tracking control is performed for the 0th recording layer, and the second tracking drive signal being obtained when the light beam is focused on the first recording layer by the focusing unit and the tracking control is performed for the first recording layer by the tracking unit; and
a relative eccentricity quantity computing unit configured to compute the relative eccentricity quantity from the eccentricity quantity of the 0th recording layer, the eccentricity quantity of the first recording layer and the phase difference.

13. An optical head apparatus, according to claim 10, wherein the second signal generator comprises:
a memory to store a plurality of waveform information corresponding to a plurality of compensation signals in digital value sequence;
a read controller to read out one of the waveform information from the memory in accordance with information indicating the relative eccentricity quantity; and
a digital-to-analog converter to convert the waveform information read out from the memory to an analog signal to generate the compensation signal.

14. An optical head apparatus according to claim 10, wherein the second signal generator comprises a variable gain amplifier to adjust optimally an amplitude of the compensation signal to minimize one of a jitter and error rate of the reproduction signal.

15. An optical head apparatus according to claim 10, wherein the second signal generator comprises a variable phase shifter to adjust optimally the phase of the compensation signal to minimize one of a jitter and error rate of the reproduction signal.

16. An optical head apparatus for reproducing information from an optical disk having a 0th recording layer and a first recording layer, comprising:
a light source to generate a light beam,
a focusing unit configured to focus the light beam on a selected one layer of a 0th recording layer and a first recording layer of an optical disk;
a tracking unit configured to perform tracking control to track the focused light beam on the selected layer;
a first signal generator including a light detector to detect reflected light from the optical disk and generate an output signal including information recorded on the selected layer;
a second signal generator to generate a compensation signal having a waveform of a frequency response determined by the relative eccentricity quantity between the 0th recording layer and the first recording layer and the position of the focused light beam with respect to a radial direction of the optical disk; and
a subtracter to subtract the compensation signal from the output signal to generate a reproduction signal.

17. An optical head apparatus according to claim 16, wherein the second signal generator is configured to derive the relative eccentricity quantity from relative eccentricity quantity information recorded on the optical disk.

18. An optical head apparatus according to claim 16, further comprising: a first detector to derive an eccentricity quantity of the 0th recording layer from a first tracking error signal obtained when the light beam is focused on the 0th recording layer by the focusing unit;
a second detector to derive an eccentricity quantity of the first recording layer from a second tracking error signal obtained when the light beam is focused on the first recording layer by the focusing unit;
a third detector to detect a phase difference between a first tracking drive signal and a second tracking drive signal, the first tracking drive signal being obtained when the light beam is focused on the 0th recording layer by the focusing unit and the tracking control is performed for the 0th recording layer, and the second tracking drive signal being obtained when the light beam is focused on the first recording layer by the focusing unit and the tracking control is performed for the first recording layer by the tracking unit; and
a relative eccentricity quantity computing unit configured to compute the relative eccentricity quantity from the eccentricity quantity of the 0th recording layer, the eccentricity quantity of the first recording layer and the phase difference.

19. An optical head apparatus, according to claim 16, wherein the second signal generator comprises:
a memory to store a plurality of waveform information corresponding to a plurality of compensation signals in digital value sequence;
a read controller to read out one of the waveform information from the memory in accordance with information indicating the relative eccentricity quantity; and
a digital-to-analog converter to convert the waveform information read out from the memory to an analog signal to generate the compensation signal.
